(19) United States
(12) Patent Application Publication
(10) Pub. No.: US 2026/0289843 A1
(43) Pub. Date: Sep. 24, 2026

(54) DISPLAY CONTROL METHOD, DISPLAY CONTROL APPARATUS, AND DISPLAY SYSTEM

(71) Applicant: CASIO COMPUTER CO., LTD., Tokyo (JP)

(72) Inventors: Toshitatsu ISHIDA, Tokyo (JP); Tomoki ISHIKAWA, Tokyo (JP); Maki MAEDA, Tokyo (JP)

(73) Assignee: CASIO COMPUTER CO., LTD., Tokyo (JP)

(21) Appl. No.: 19/573,662

(22) Filed: Mar. 20, 2026

(30) Foreign Application Priority Data
Mar. 21, 2025 (JP) 2025-046399

(51) Int. Cl. G06T 11/26

(52) U.S. Cl. CPC G06T 11/26; G06T 2200/24

(57) ABSTRACT

A display control method executed by one or more processors, the method including: based on history information representing history of a state of an object, displaying a portion of a plurality of time period information representing the state of the object in a predetermined first time period in chronological order in a first display region of a display; displaying a graph representing a time-series change of a parameter regarding the history information in the first time period in a second display region; in response to receiving an operation designating a position in the second display region, based on a designated time corresponding to the designated position, determining a target time period; and changing a portion of the time period information in a manner in which the time period information corresponding to the determined target time period is displayed at a predetermined position in the first display region.

### CROSS-REFERENCE TO RELATED APPLICATION

This application is based upon and claims the benefit of priority from the prior Japanese Patent Application No. 2025-046399, filed on Mar. 21, 2025, the entire contents of which are incorporated herein by reference.

### BACKGROUND

### Field

The present disclosure relates to a display control method, a display control apparatus, and a display system.

### Description of Related Art

Conventionally, a robot capable of performing simulated communication with a user by performing various operations according to its state is known (e.g., Japanese Unexamined Patent Application Publication No. 2002-59389).

### SUMMARY

According to one aspect of the present disclosure, a display control method executed by one or more processors, the method including:

based on history information representing history of a state of an object, displaying a portion of a plurality of time period information representing the state of the object in a predetermined first time period in chronological order in a first display region of a display;

displaying a graph representing a time-series change of a parameter regarding the history information in the first time period in a second display region different from the first display region of the display;

in response to receiving an operation designating a position in the second display region, based on a designated time corresponding to the designated position along a time axis of the graph, determining a target time period that satisfies a predetermined condition from among a plurality of target time periods within the first time period; and

changing a portion of the plurality of time period information to be displayed in the first display region in a manner in which the time period information corresponding to the determined target time period among the plurality of time period information is displayed at a predetermined position in the first display region.

### BRIEF DESCRIPTION OF DRAWINGS

FIG. 1 is a diagram showing a configuration of a robot management system.

FIG. 2 is a schematic diagram showing a configuration of a main body of a robot.

FIG. 3 is a block diagram showing a functional configuration of the robot.

FIG. 4 is a diagram showing contents of a log.

FIG. 5 is a diagram showing an emotion map.

FIG. 6 is a block diagram showing a functional configuration of a smartphone.

FIG. 7 is a diagram showing contents of state information.

FIG. 8 is a diagram showing a home screen.

FIG. 9 is a diagram showing an interaction record screen.

FIG. 10 is a diagram showing the interaction record screen with a calendar displayed.

FIG. 11 is a diagram showing the interaction record screen in response to an operation designating a position.

FIG. 12 is a diagram showing a first time period, a second time period, a unit time period, a designated position, and a designated time point in a graph display region.

FIG. 13 is a diagram showing the interaction record screen in response to the operation designating the position.

FIG. 14 is a flowchart showing a control procedure for a timeline display process.

FIG. 15 is a flowchart showing the control procedure for the timeline display process.

### DETAILED DESCRIPTION

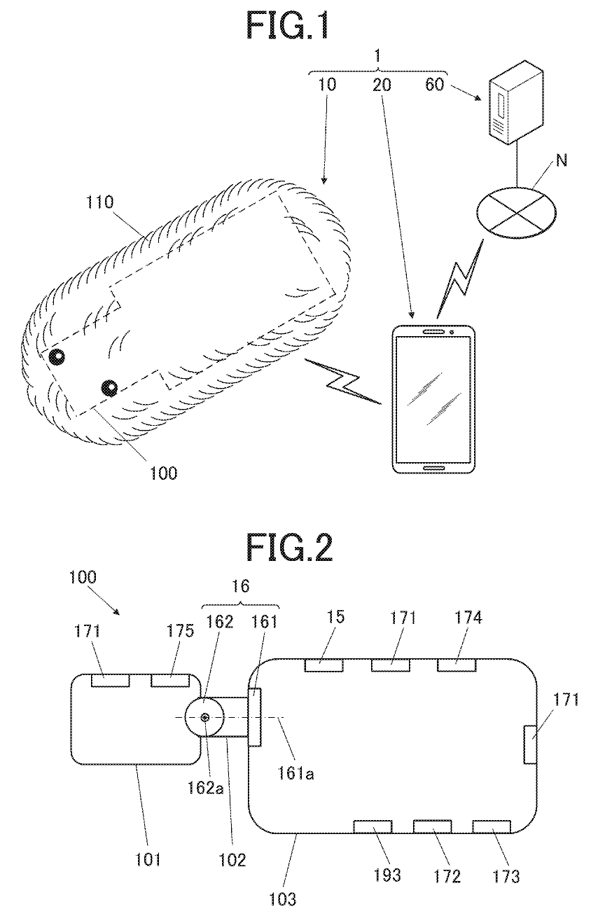

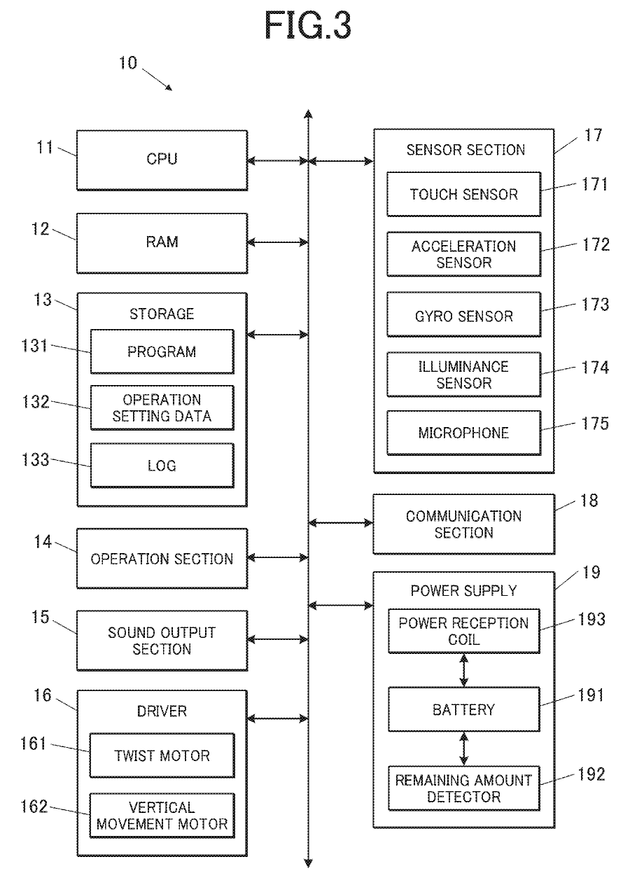

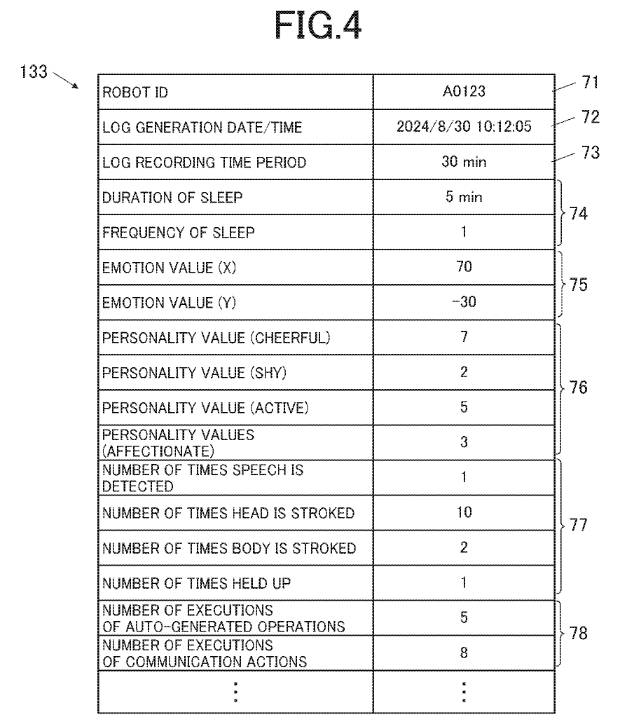

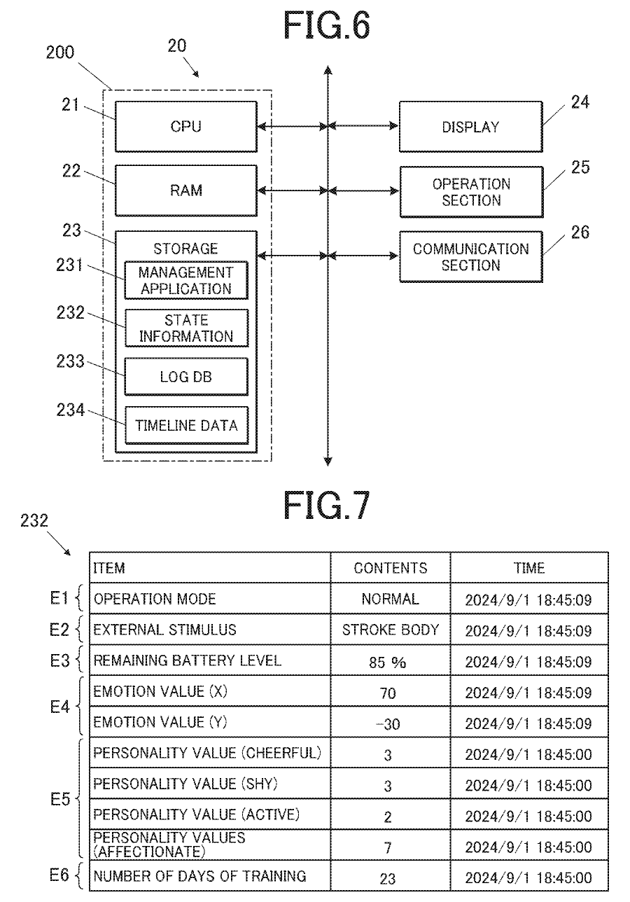

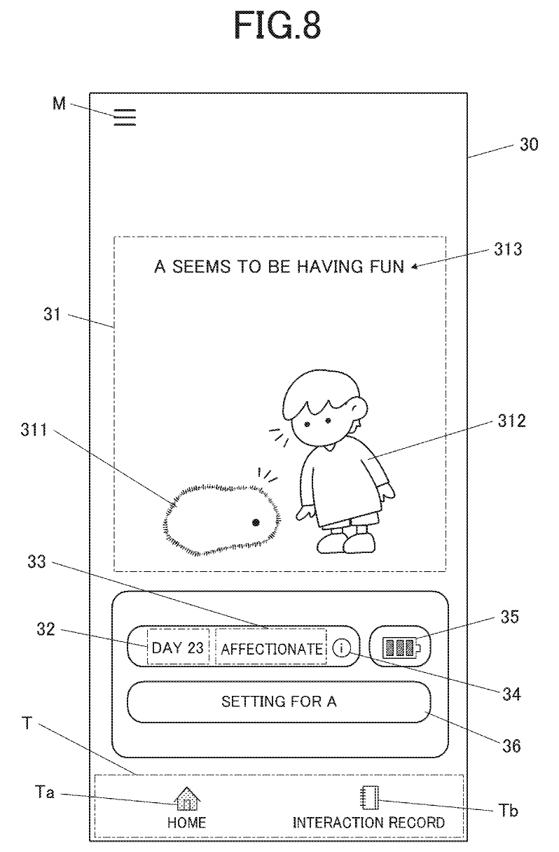

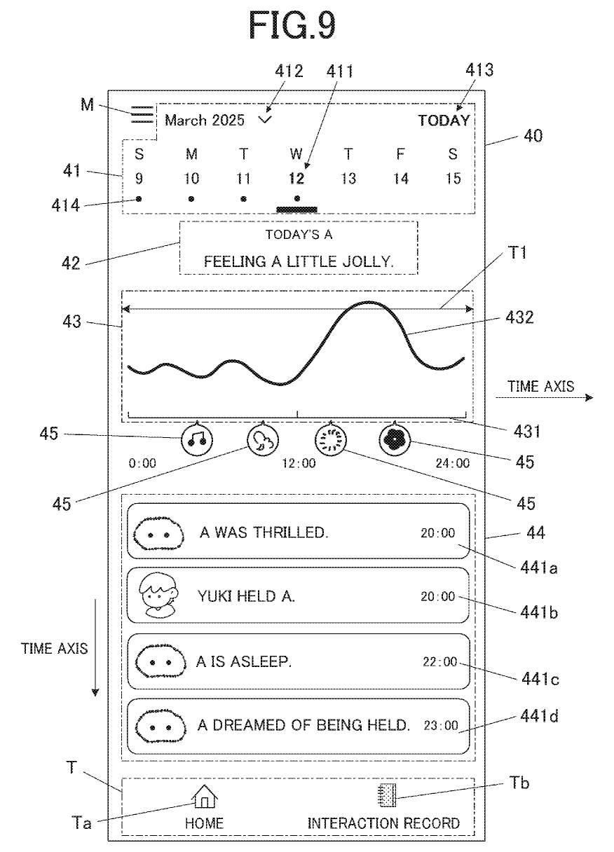

The following is a description of the embodiments of the present disclosure based on the drawings. As shown in FIG. 1, a robot management system 1 (display system) includes a robot 10 (object), a smartphone 20 (terminal device), and a server 60 (information processing apparatus). The robot 10 includes a main body 100 and an exterior 110 that covers an entire surface of the main body 100. The robot 10 is a pet robot that mimics a small creature. The robot 10 can perform multiple operations that differ from each other to mimic gestures of the creature. The exterior 110 is made of a flexible material and deforms in response to a movement of the main body 100. The exterior 110 includes, for example, fur formed by pile fabric and decorative members that resemble eyes. The smartphone 20 is capable of communicating and connecting with the robot 10 via short-range wireless communication. According to the present embodiment, BLE (Bluetooth (registered trademark) Low Energy) is used for the short-range wireless communication. However, methods of the short-range wireless communication other than BLE may be used. The robot 10 and the smartphone 20 operate in coordination with each other by sending and receiving data through a communication connection using BLE. For example, the smartphone 20 obtains state information 232 (see FIGS. 6 and 7) representing the latest state of the robot 10 from the robot 10. Based on the state information 232, the smartphone 20 allows the display 24 to display on a management application 231 (program) (see FIG. 6) used to manage the robot 10 as an object a home screen (see FIG. 8) including various information representing a state of the robot 10. The smartphone 20 also acquires a log 133 (see FIGS. 3 and 4) generated in the robot 10 from the robot 10 and accumulates the log 133 in a log database (DB) 233 (see FIG. 6). The log 133 and the log DB 233 are each a form of history information representing a history of the state of the robot 10. Based on the log DB 233, the smartphone 20 allows the display 24 to display on the management application 231 an interaction record screen 40 (see FIG. 9) which includes various information pertaining to the history of the state of the robot 10. It may be possible to link two or more robots 10 to one smartphone 20. Other types of devices such as a tablet terminal, a smartwatch, a laptop PC or a management server may be used instead of the smartphone 20. The smartphone 20 is connected for communication with the server 60 via a network N such as the Internet. The smartphone 20 forwards the log 133 obtained from the robot 10 to the server 60. The log 133 accumulated on the server 60 is referred to as backup of the log 133, for example.

As shown in FIG. 2, the main body 100 of the robot 10 includes a head 101, a body 103, and a coupling 102 that connects the head 101 and the body 103. The main body 100 includes a driver 16 that moves the head 101 with respect to the body 103. The driver 16 includes a twist motor 161 and a vertical movement motor 162. The twist motor 161 is a servo motor that rotates the head 101 and the coupling 102 around a first rotation axis 161a within a predetermined angular range. The first rotation axis 161a extends in an extending direction of the coupling 102. The operation of the twist motor 161 enables the robot 10 to twist the head 101. The vertical movement motor 162 is a servo motor that rotates the head 101 around a second rotation axis 162a within a predetermined angular range. The second rotation axis 162a is perpendicular to the first rotation axis 161a. The vertical movement motor 162 enables the robot 10 to move the head 101 up and down. A direction of a vertical movement of the head 101 can also be an inclined direction with respect to a vertical direction, depending on an angle of a twist of the head 101 by the twist motor 161. By operating the twist motor 161 and/or the vertical movement motor 162 in a finely periodic manner, the robot 10 can achieve a shaking or trembling motion of the head 101. By changing timing, magnitude, and speed of the operation of the twist motor 161 and the vertical movement motor 162, and combining them as appropriate, the robot 10 can be made to perform a variety of operations, for example, a joyful operation, a surprised operation, a breathing operation that mimics the breathing of the creature, and the like. Among these, the breathing operation is a form of spontaneous operation by the robot 10.

As shown in FIG. 2, the main body 100 includes a touch sensor 171, an acceleration sensor 172, a gyro sensor 173, an illuminance sensor 174, a microphone 175, a sound output section 15, and a power reception coil 193. The touch sensors 171 are provided on the top of the head 101 and the top and the side of the body 103. The acceleration sensor 172, the gyro sensor 173, and the power reception coil 193 are provided near a lower surface of the body 103. The illuminance sensor 174 and the sound output section 15 are provided at the top of the body 103. The microphone 175 is provided at the top of the head 101 near a base of the head 101.

As shown in FIG. 3, the robot 10 includes a CPU 11 (Central Processing Unit), a RAM 12 (Random Access Memory), a storage 13, an operation section 14, a sound output section 15, a driver 16, a sensor section 17, a communication section 18, and a power supply 19. Each part of the robot 10 is connected via a data transmission path such as a bus, etc. Each of the functional configurations shown in FIG. 3 is provided in the main body 100.

The CPU 11 is a processor that reads and executes a program 131 stored in the storage 13 and performs various arithmetic processes to control the operation of the robot 10. The robot 10 may include a plurality of processors (e.g., plurality of CPUs), and the plurality of processes executed by the CPU 11 according to the present embodiment may be executed by such plurality of processors. In this case, the plurality of processors may be involved in a common process, or the plurality of processors may independently execute different processes in parallel. The RAM 12 provides a working memory space for the CPU 11 and stores temporary data. The storage 13 is a non-transitory recording medium readable by the CPU 11 as a computer and stores the program 131 and various data. Thus, the storage 13 encompasses a computer program product that includes the program 131. The storage 13 includes a nonvolatile memory, such as a flash memory, for example. The program 131 is stored in the storage 13 in a form of a computer-readable program code. The program 131 contains firmware to control each hardware of the robot 10. The data stored in the storage 13 includes operation setting data 132 and the log 133 that includes information representing the history of the robot 10. The contents of the operation are set in the operation setting data 132. Examples of the operations include, communication operations performed by the robot 10 according to the state of the robot 10 or the contents of external stimuli, automatically generated operations that the robot 10 performs spontaneously without external stimuli, breathing operation, and the like. The automatically generated operations can be described as whimsical operations, as the robot 10 appears to gesture whimsically. Settings pertaining to the content of the operation include, for example, settings for the timing and amount of the operation of the twist motor 161 and the vertical movement motor 162 of the driver 16, as well as settings for a pitch, length, and volume of a sound output by the sound output section 15.

The log 133 is generated by the CPU 11 for each recording time period of a predetermined length and stored in the storage 13. The log 133 includes information representing the history of the robot 10 during each recording time period. According to the present embodiment, a recording time period is 30 minutes. However, in a case in which a special process that may prevent generation of the log 133 is performed at the timing of the generation of the log 133 which is every 30 minutes, the log 133 is generated at the timing before the start of the special process. In this case, the recording time period is less than 30 minutes. As shown in FIG. 4, the log 133 generated in one log save includes a robot ID 71, a log generation date/time 72, a recording time period 73 of the log 133, sleep information 74, an emotion parameter 75, a personality parameter 76, stimulus count information 77, and operation count information 78. The robot ID 71 is a unique symbol assigned to the robot 10. The log generation date/time 72 is the date and time (hours, minutes, seconds) when the log 133 was generated. The recording time period 73 represents the length of the time period during which the history reflected in that log 133 was recorded. As described above, the recording time period 73 is normally 30 minutes, but may be less than 30 minutes. The sleep information 74 includes information on the length of time the robot 10 was in sleep mode, which mimics sleep of the living creature, during the recording time period 73 and the number of times the robot 10 was in the sleep mode. The robot 10 maintains a sleepiness parameter that indicates sleepiness according to a surrounding environment (e.g., illumination intensity) and an external stimulus, and enters the sleep mode when this sleepiness parameter becomes equal to or larger than a predetermined value.

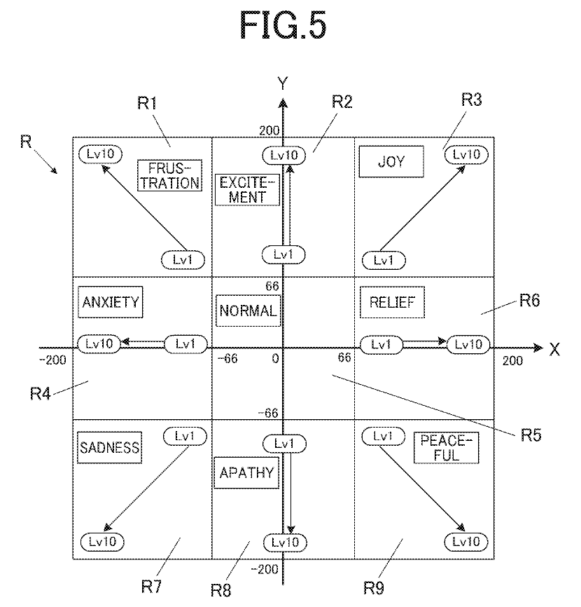

The emotion parameter 75 indicates the history of a simulated emotion of the robot 10. The emotion parameter 75 consists of "emotion value (X)" and "emotion value (Y)" (hereinafter also collectively referred to as "emotion value") representing the emotion of the robot 10 at a predetermined time point (e.g., a starting time point of the recording time period) during the recording time period of the log 133. The emotion value represents the simulated emotion of the robot 10 according to the position of a plot in an emotion map in an XY coordinate plane shown in FIG. 5. The "emotion value (X)" is the position in an X-axis direction of the plot, with larger values indicating higher levels of relief and smaller values indicating higher levels of anxiety. The "emotion value (Y)" is the position in a Y-axis direction of the plot, with larger values indicating higher levels of excitement and smaller values indicating higher levels of apathy. A maximum value of the "emotion value (X)" is "200" and a minimum value is "-200". The maximum value of the "emotion value (Y)" is "200" and the minimum value is "-200". Therefore, the emotion value is one of the coordinates within a square emotion region R, which has a length of 400 on one side. The emotion region R of the emotion map is divided into multiple regions R1 to R9 corresponding to multiple emotions that differ from each other. The regions R1 to R9 are square regions arranged in a 3 × 3 matrix. The regions R1 to R9 each represent an emotion of the robot 10. The region R1 satisfying -200 ≤ X ≤ -67 and 67 ≤ Y ≤ 200 represents the emotion of "frustration". The region R2 satisfying -66 ≤ X ≤ 66 and 67≤ Y ≤ 200 represents the emotion of "excitement". The region R3 satisfying 67 ≤ X ≤ 200 and 67 ≤ Y ≤ 200, represents the emotion of "joy". The region R4 satisfying -200 ≤ X ≤ -67 and -66 ≤ Y ≤ 66 represents the emotion of "anxiety". The region R5 satisfying -66 ≤ X ≤ 66 and -66 ≤ Y ≤ 66 represents the emotion of "normal". The region R6 satisfying 67 ≤ X ≤ 200 and -66 ≤ Y ≤ 66 represents the emotion of "relief". The region R7 satisfying -200 ≤ X ≤ -67 and -200 ≤ Y ≤ -67 represents the emotion of "sadness". The region R8 satisfying -66 ≤ X ≤ 66 and -200 ≤ Y ≤ -67 represents the emotion of "apathy". The region R9 satisfying 67≤ X ≤ 200 and -200 ≤ Y ≤ -67 represents the emotion of "peaceful". The regions R1 to R4 and R6 to R9, which correspond to the eight types of emotions except "normal," are further divided into ten level regions ("Lv1" to "Lv10"), each interior representing ten levels of the emotion (degree of emotion). In each of the regions R1 to R4 and R6 to R9, the closer to the "normal" region R5, the level region with the lower level is located, and the farther from the "normal" region R5, the level region with the higher level is located. Among the nine types of emotions, the following four emotions are positioned as positive emotions, excitement, joy, relief, and peaceful. The length of one side of the emotion region R and the regions R1 to R9 may increase within a range as the robot 10 grows. For example, the emotion region R in an initial state may be a region -100≤ X ≤ 100 and -100 ≤ Y ≤ 100, and may increase to the region -200 ≤ X ≤ 200 and -200 ≤ Y ≤ 200 as the robot 10 grows. The emotion value changes from time to time in response to external stimuli received by the robot 10. The amount of change in one emotion value is selected from the following variables DXP, DXM, DYP, and DYM.
DXP: Amount of change in + X direction DXM:
Amount of change in - X direction DYP:
Amount of change in + Y direction DYM:
Amount of change in - Y direction

It can also be said that the variable DXP represents ease of feeling relief, the variable DXM represents ease of feeling anxious, the variable DYP represents ease of feeling excited, and the variable DYM represents ease of feeling apathetic. According to the present embodiment, an initial value of the variables DXP, DXM, DYP, and DYM is "10". The variables DXP, DXM, DYP, and DYM are increased by a predetermined amount when the emotion values reach their maximum values in the +X-axis direction, -X-axis direction, +Y-axis direction, and -Y-axis direction, respectively. According to the present embodiment, the maximum value of the variables DXP, DXM, DYP, and DYM is "20".

The personality parameter 76 shown in FIG. 4 represents the history of the simulated personality of the robot 10. The personality parameter 76 represents the personality of the robot 10 at a predetermined time point (e.g., the starting time point of the recording time period) during the recording time period of the log 133. The personality parameter 76 includes "personality value (cheerful)," "personality value (shy)," "personality value (active)," and "personality value (affectionate)" (hereinafter collectively referred to as "personality values"). The "personality value (cheerful)" is the value acquired by subtracting "10" from the variable DXP, and represents the likelihood of the change on the emotion map in the X-axis positive direction, i.e., the likelihood of becoming relieved. The "personality value (shy)" is the value acquired by subtracting "10" from the variable DXM, and represents the likelihood of the change on the emotion map in the X-axis negative direction, i.e., the likelihood of becoming anxious. The "personality value (active)" is the value acquired by subtracting "10" from the variable DYP and represents the likelihood of the change on the emotion map in the Y-axis positive direction, i.e., the likelihood of becoming excited. The "personality value (affectionate)" is the value acquired by subtracting "10" from the variable DYM and represents the likelihood of the change on the emotion map in the Y-axis negative direction, i.e., the likelihood of becoming apathetic. Therefore, each personality value changes according to the change in the variables DXP, DXM, DYP, and DYM, with the initial value being "0" and the maximum value being "10". Thus, the four personality values represent degrees of the four personalities. The personality corresponding to the largest personality value among the four personality values is considered to be the personality of the robot 10 at that time point. For example, in the example shown in FIG. 4, the "personality value (cheerful)" is the largest at "7", so the personality of the robot 10 at this time point is set to "cheerful". In response to two or more personality values being identical and maximum, one personality is determined according to a predetermined priority order. According to the present embodiment, the priority order of the personality is, from highest to lowest, "cheerful," "active," "shy," and "affectionate".

The stimulus count information 77 represents the number of times the robot 10 received the predetermined stimulus from the outside (external stimulus) during the log recording time period. In FIG. 4, the number of times a spoken voice was detected, the number of times the head was stroked, the number of times the body was stroked, and the number of times the body was held up are examples of the stimulus count information 77. For example, the external stimulus may include, but is not limited to, "loud noise", "upside down", "swinging", etc. The external stimulus related to sound, such as "talking" or "loud noise", is detected based on sensing data from the microphone 175. The external stimulus related to contact, such as "stroke body" or "stroke head," is detected based on the sensing data from the touch sensor 171. The external stimulus related to a change in posture such as "lifting", "upside down", and "swinging" are detected based on the sensing data from the acceleration sensor 172 and the gyro sensor 173. The operation count information 78 represents the number of times the robot 10 has performed the predetermined operation during the recording time period of the log. In FIG. 4, the number of times the automatically generated operation and communication operation described above have been performed is illustrated as the operation count information 78. The log 133 in FIG. 4 is an example and can be modified as needed. For example, a number of transitions to a taming mode that the robot 10 enters when the robot 10 is tamed by the user, the number of times the robot 10 receives the stimulus from the user in the taming mode, the number of times the robot 10 performs a predetermined operation in the taming mode, etc. may be recorded in the log 133.

Thus, the log 133 is not in the form of sequential records in chronological order showing the state, the operation, and the received stimulus of the robot 10. Instead, the log 133 is in the form of a summary of statistical values (number of times, frequency, length of time, etc.) and representative values (emotion values, personality values, etc.) for each item of the state, the operation, and the received stimulus of the robot during a log recording time period. In other words, the log 133 is a package format that represents the history representing the robot 10 during the log recording time period, aggregated into a predetermined number of items. This can greatly reduce a data amount in the log 133 compared to the sequential recording format.

The operation section 14 shown in FIG. 3 includes operation buttons, an operation knob, etc. for turning the power on and off, adjusting the volume of the sound output by the sound output section 15, and so on. The operation section 14 outputs to the CPU 11 operation information according to input operation on the operation buttons and the operation knob. The sound output section 15 includes a speaker and outputs the sound at the pitch, length, and volume according to a control signal and sound data transmitted from the CPU 11. Such sound may be the sound that imitates a cry of the creature. The driver 16 operates the twist motor 161 and the vertical movement motor 162 described above according to the control signal transmitted from the CPU 11.

The sensor section 17 includes the touch sensor 171, the acceleration sensor 172, the gyro sensor 173, the illuminance sensor 174, and the microphone 175 described above, and outputs the sensing results from each sensor and the microphone 175 to the CPU 11. The touch sensor 171 senses that the user or other object made contact with the robot 10. The touch sensor 171 includes a pressure sensor or a capacitance sensor, for example, and outputs to the CPU 11 the sensing data regarding whether there is contact with the robot 10. The acceleration sensor 172 senses acceleration for each of three orthogonal axis directions and outputs the sensing data to the CPU 11. The gyro sensor 173 senses angular velocity around each of the three orthogonal axis directions and outputs the sensing data to the CPU 11. The illuminance sensor 174 senses ambient brightness around the robot 10 and outputs the sensing data to the CPU 11. The microphone 175 senses the sound around the robot 10 and outputs the sensed sound data to the CPU 11.

The communication section 18 is a communication module including an antenna, a modulation and demodulation circuit, a signal processing circuit, etc., and performs wireless data communication with the smartphone 20 according to a BLE communication standard. The power supply 19 includes a battery 191, a remaining amount detector 192, and the power reception coil 193. The battery 191 supplies power to various parts of the robot 10. The battery 191 according to the present embodiment is a rechargeable battery that can be repeatedly recharged using a non-contact recharging method. The remaining amount detector 192 detects a remaining battery level of the battery 191 according to the control signal sent from the CPU 11 and outputs the detection results to the CPU 11. The charging operation of the battery 191 is performed with the robot 10 stored (installed) inside a dedicated power feeder (storage unit, charging dock), which is not shown in the drawings. The power feeder includes a power transmission coil for charging the battery 191 by electromagnetic induction at a position opposite the power reception coil 193 when the robot 10 is stored.

As shown in FIG. 6, the smartphone 20 includes a CPU 21 (one or more processors), a RAM 22, a storage 23, a display 24, an operation section 25, and a communication section 26. Each part of the smartphone 20 is connected via the data transmission path such as the bus, etc. The CPU 21, the RAM 22, and the storage 23 constitute a display control apparatus 200 that controls a display operation of the display 24.

The CPU 21 is a processor that controls the operation of the smartphone 20 by reading and executing programs such as the management application 231 stored in the storage 23 and performing various arithmetic processing. The smartphone 20 may include the plurality of processors (e.g., plurality of CPUs), and the plurality of processes executed by the CPU 21 according to the present embodiment may be executed by such plurality of processors. In this case, one or more processors are composed of multiple processors. In this case, the plurality of processors may be involved in a common process, or the plurality of processors may independently execute different processes in parallel. The RAM 22 provides a working memory space for the CPU 21 and stores temporary data. The storage 23 is a non-transitory recording medium readable by the CPU 21 as the computer and stores the program such as the management application 231 and various data. Thus, the storage 23 encompasses the computer program product that includes the program. The management of the robot 10 by the management application 231 means displaying at least information pertaining to the state of the robot 10 on a predetermined display. The storage 23 includes a nonvolatile memory, such as a flash memory, for example. The data stored in the storage 23 includes state information 232, log DB 233 (history information), timeline data 234, etc.

As shown in FIG. 7, the state information 232 includes data pertaining to each of the elements E1 to E6, which represent the latest state of the robot 10. In detail, the state information 232 includes data representing the contents of each of the elements E1 to E6 and information on the time when each data was generated in the robot 10 (or the time when the data was received by the smartphone 20). The element E1 is an "operation mode" of the robot. The operation mode of the robot 10 according to the present embodiment includes "normal mode," "deep sleep mode," and the "sleep mode" described above. The "normal mode" is a mode in which the robot 10 performs communicative operations in response to external stimuli or performs automatically generated operations in response to predetermined conditions being met. The "deep sleep mode" is a mode in which the head 101 of the robot 10 stops moving and the sound output from the sound output section 15 stops. The "deep sleep mode" is executed in response to an operation on the setting screen (not shown) to instruct the shift to the deep sleep mode. The element E2 is "external stimulus" and represents the type of stimulus that the robot 10 receives from the outside. The element E3 is the "remaining battery level" of the battery 191. The "remaining battery level" is expressed as a percentage in which the fully charged battery is shown as 100%. The "remaining battery level" is detected by the remaining amount detector 192. The element E4 is the latest emotion value of the robot 10. The element E5 is the latest personality value of the robot 10. The element E6 is the "number of days of training" and represents the number of days (cumulative operation time period) calculated from the date the robot 10 was first started. Among the elements E1 to E6, the elements E1, E2, and E4 to E6 are states of the element (information) that is updated according to the history of the robot 10.

Each of the data for the elements E1 to E6 is sequentially generated by the CPU 11 of the robot 10 according to an operating status of the robot 10 and stored in the storage 13 of the robot 10 along with the time that the data is generated. In response to the connection for communication being in progress with the robot 10 via BLE, the CPU 21 of the smartphone 20 repeatedly acquires the elements E1 to E6 of the state information 232 from the robot 10 at a predetermined frequency and updates the state information 232. In detail, the CPU 21 acquires and updates the data for the elements E1 to E4 in the state information 232 from the robot 10 at a frequency of once per second. In addition, the CPU 21 acquires and updates the data for the elements E5 and E6 in the state information 232 from the robot 10 at a frequency of once per minute. Updating the state information 232 in this manner is equivalent to acquiring the state information 232. The format of the state information 232 is not limited to that shown in FIG. 6. For example, the state information 232 may be in the form of a queue that accumulates the elements E acquired from the robot 10 in chronological order.

The log DB 233 shown in FIG. 6 accumulates the log 133 obtained from the robot 10. In response to the connection for communication being in progress between the robot 10 and the smartphone 20 via BLE, the logs 133 generated by the robot 10 every 30 minutes are sequentially sent to the smartphone 20. Apart from the above, in response to the user instructing on the management application 231 to acquire the log 133, the CPU 21 of the smartphone 20 sends a request to the robot 10 to transfer the log 133, and acquires the log 133 from the robot 10. The CPU 21 transfers the log 133 obtained from the robot 10 to the server 60 also. Therefore, the server 60 stores the data with the same contents as the log DB 233 (hereinafter referred to as a backup log). At a predetermined timing, the CPU 21 determines whether the log DB 233 in the storage 23 and the backup log stored in the server 60 match, and in response to determining that there is no match, the CPU 21 obtains the backup log from the server 60 and modifies the contents of the log DB 233. The predetermined timing may be, for example, the timing for updating the display of the home screen 30 and the interaction record screen 40, as described below.

The display 24 includes a display panel, such as a liquid crystal panel, capable of displaying in a dot matrix format, and a driving circuit for such display panel. The display 24 displays various menus, screens of the management application 231, etc. according to the control signal sent from the CPU 21. The operation section 25 includes an operation means such as a touch screen and operation buttons that are provided overlapped on a display panel of the display 24, and outputs operation signals corresponding to the operation on the operation means to the CPU 21. The communication section 26 is a communication module including the antenna, the modulation and demodulation circuit, the signal processing circuit, etc., and performs wireless data communication with the robot 10 according to the BLE communication standard. The communication section 26 transmits and receives voice data for telephone communication and packet data for Internet connection to and from a base station.

The operation of the robot management system 1 is described next. In response to the user operating the operation section 25 of the smartphone 20 in order to instruct the start of the management application 231, the CPU 21 executes and starts the management application 231. The display operation of the display 24 described below is executed by the CPU 21 executing a predetermined process in accordance with the management application 231 and controlling the display 24. In response to the management application 231 starting, the CPU 21 acquires each element of the state information 232 from the robot 10 and displays the home screen 30 shown in FIG. 8 on the display 24 based on the state information 232. Before displaying the home screen 30, a predetermined splash screen or welcome screen may be displayed. The CPU 21 acquires the elements E1 to E6 of the state information 232 from the robot 10 at the frequency described above, updates the state information 232, and updates the home screen 30 based on the latest state information 232. The home screen 30 displays a state image 31, a growth days image (image showing number of days of growth) 32, a personality image 33, an information mark 34, a remaining battery level image 35, a setting button 36, a menu mark M, and a tab bar T in a predetermined arrangement. The letter "A" in FIG. 8 is the name given to the robot 10 by the user on the management application 231. The state image 31, the growth days image 32, the personality image 33, and the remaining battery level image 35 represent the state of the robot 10. Thus, the home screen 30 contains various information pertaining to the state of the robot 10. By viewing the home screen 30, the user can learn about the real-time state of the robot 10.

The state image 31 includes an outer appearance image 311 representing an element of the state of the robot 10 by the outer appearance of the robot 10 and an avatar image 312 representing the outer appearance of the user's avatar. The outer appearance image 311 and the avatar image 312 are animated videos having a predetermined length. The state image 31 includes a text 313 representing the element of the state of the robot 10. The growth days image 32 includes information on the number of growth days corresponding to the element E6 in the state information 232. The personality image 33 displays the personality corresponding to the personality value that is the largest of the four personality values in the element E5 of the state information 232. The information mark 34 functions as an operation button for displaying the detailed information screen (not shown), including the detailed information representing the personality of the robot 10. The remaining battery level image 35 is an image showing the remaining battery level of the battery 191 in three levels. In response to the operation to select the setting button 36, the CPU 21 displays a setting screen (not shown) on the display 24 for setting the operation of the robot 10. In response to the operation to select the menu mark M, the CPU 21 displays the menu screen (not shown) on the display 24. The menu screen can further display a screen for editing a profile of the user, a screen listing the robots 10 that are linked, a screen for newly registering (linking) the robot 10, and a screen displaying information such as the version of the management application 231. The tab bar T is displayed at the bottom of the home screen 30. The tab bar T displays a home icon Ta for displaying the home screen 30 and an interaction record icon Tb for displaying the interaction record screen 40. In response to the interaction record icon Tb being selected while the home screen 30 is displayed, the CPU 21 transitions the display on the display 24 from the home screen 30 to the interaction record screen 40 shown in FIG. 9.

The interaction record screen 40 displays various information pertaining to the history of interaction between the robot 10 and the user. The interaction record screen 40 includes a date selection section 41, pickup information 42, a graph display region 43 (second display region), a timeline display region 44 (first display region), an emotion icon 45, a menu mark M, and a tab bar T. Among the above, the function of the menu mark M is identical to the function of the menu mark M on the home screen 30 in FIG. 8. The configuration of the tab bar T is identical to the configuration of the tab bar T on the home screen 30. In response to the home icon Ta being selected in the tab bar T of the interaction record screen 40, the CPU 21 transitions the display in the display 24 from the interaction record screen 40 to the home screen 30.

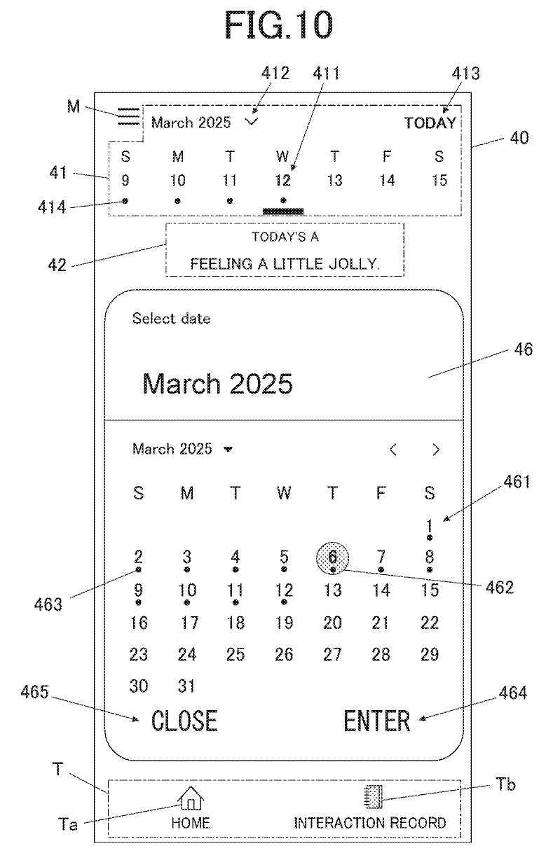

The date selection section 41 displays dates 411 for one week, a calendar display icon 412, a today button 413, an interaction mark 414, and the like. In response to the operation to select a date 411 (e.g., tapping the position of the date 411), the CPU 21 updates the contents of the interaction record screen 40 with information pertaining to the history of interaction on the selected date 411. The interaction mark 414 is displayed at the bottom of the date 411 where the information is displayed on the interaction record screen 40. In response to the operation to select the calendar display icon 412, the CPU 21 displays the calendar 46 shown in FIG. 10 on the interaction record screen 40. The calendar 46 displays a date 461, a selected mark 462, an interaction mark 463, an enter button 464, and a close button 465. In response to the operation to select the date 461, the selected mark 462 is displayed at the position of the date 461. In response to the enter button 464 being selected with the selected mark 462 displayed on any date 461, the CPU 21 closes the calendar 46 and updates the contents of the interaction record screen 40 with information pertaining to the history of the interaction on the selected date 461. The interaction mark 463 is displayed at the bottom of the date 461 in which the information is displayed on the interaction record screen 40. In response to the close button 465 being selected, the CPU 21 closes the calendar 46. In response to the operation to select the today button 413 shown in FIG. 9, the CPU 21 updates the contents of the interaction record screen 40 with information pertaining to the history of the interaction on the same day (today).

The pickup information 42 shown in FIG. 9 displays the characteristic changes that have occurred in the robot 10 during a recent time period. According to the present embodiment, a time period is one day of one day before. In response to, based on the latest log DB 233, determining whether a change that satisfies a predetermined change condition has occurred in the state of the robot 10 on the previous day, and determining that a change that satisfies the change condition has occurred, the CPU 21 displays the pickup information 42 as change information indicating that the change occurred on the previous day on the display 24. The pickup information 42 displays the change in the emotion or the change in the personality as the state of the robot 10.

The graph display region 43 displays a coordinate axis 431 which represents a time axis, and a graph 432. The graph 432 represents a time-series change in the first time period T1 of a state parameter P regarding the log DB 233. That is, the value on the vertical axis of the graph 432 is the state parameter P. The first time period T1 is a predetermined time frame of at least a part of one day, and according to the present embodiment, the first time period T1 is all time frames of one day, that is, 24 hours. The state parameter P to be plotted in the graph 432 may be one of the parameters itself contained in the log DB 233, or may be the parameter derived by a predetermined rule from two or more parameters contained in the log DB 233. According to the present embodiment, the state parameter P is used to reflect the emotion of the robot 10. The CPU 21 derives the state parameter P in the following method based on the emotion value (X) and the emotion value (Y) at each time. That is, the CPU 21 sets P = |X| + |Y| in response to 120 ≤ X at one time of day. In response to 0 ≤ X < n, it is set that P = (|X | + |Y |)/2. Here, n is an integer satisfying 0 < n < 200. In response to -n < X < 0, it is set that P = -(|X| + |Y|)/2. In response to X ≤ -n, it is set that P=-(|X|+ |Y|). In response to P derived by the above being a negative value, the CPU 21 further multiplies the derived value by 1/2. The derived state parameters P at each time may be plotted as is on the graph 432 and the graph 432 may be drawn, but according to the present embodiment, the CPU 21 draws the graph 432 by thinning out the state parameters P to be plotted and then smoothly connecting these state parameters P. Specifically, the CPU 21 divides one day into four sections. Each of the sections is six hours and the dividing starts from midnight. The three state parameters P to be plotted are extracted for each section. In detail, the CPU 21 first further divides the section into three subsections which are two hours each. Next, the CPU 21 extracts the maximum value of the state parameter P in the section. Next, the CPU 21 extracts the minimum value of the state parameter P from the two subsections excluding the subsection containing the maximum value. Next, the CPU 21 extracts the median value of the state parameter P in the remaining subsection that does not include the maximum and minimum values. The CPU 21 plots the maximum, minimum and median values extracted in this manner for each section on the graph display region 43. Therefore, the CPU 21 plots a total of 12 points for the four sections and draws the graph 432 by connecting the points with a smooth curve. Such drawing method allows the graph 432 to reflect the trend of the increase or decrease of the state parameter P, while reducing the fine irregularities in the graph 432. The above is an example of how to thin out the plot of the state parameter P, and is not limited to this.

The emotion icon 45 is displayed at the bottom of the graph display region 43. The emotion icon 45 is an index showing the emotion of the robot 10 changed from one emotion to one of the positive emotions. Each emotion icon 45 includes an image representing the emotion after the change. The emotion icon 45 is displayed on the coordinate axis 431 at the position corresponding to a change timing when the emotion of the robot 10 changed from one emotion to any of the positive emotions.

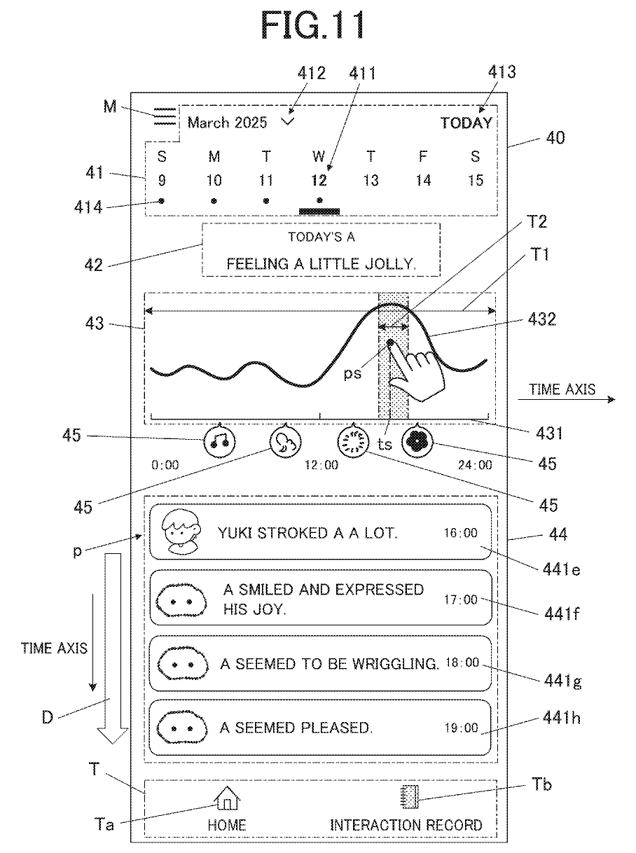

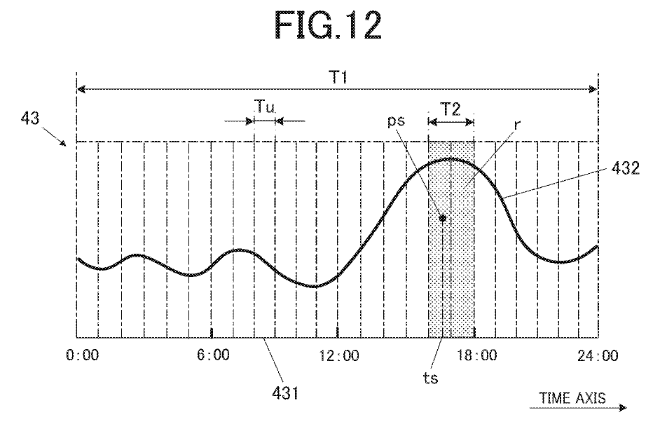

In the timeline display region 44, a plurality of (in FIG. 9, four) timeline information 441 (time period information) are displayed in chronological order in the vertical direction (a direction). Each timeline information 441 is generated based on the log DB 233 and each represents the representative state of the robot 10 in a unit time period Tu (see FIG. 12) with a predetermined length as a target time period. According to the present embodiment, for example, the unit time period Tu is a one-hour time frame from a top of the hour to the next top of the hour. The timeline information 441 can be one of the following four types. A first type is the timeline information 441 (e.g., timeline information 441c in FIG. 9) representing a sleep state of the robot 10 in the unit time period Tu. A second type is the timeline information 441 (e.g., timeline information 441g in FIG. 11) representing a spontaneous operation performed by the robot 10 during the unit time period Tu. A third type is the timeline information 441 (e.g., timeline information 441b in FIG. 9) representing the external stimulus received by the robot 10 through communication with the user during the unit time period Tu. A fourth type is the timeline information 441 (e.g., timeline information 441a in FIG. 9) representing the emotion of the robot 10 during the unit time period Tu. The number of timeline information 441 displayed for a unit time period Tu is at most one for each type, thus a maximum of four in total. Two or more timeline information 441 that are different from each other and that correspond to the same state of the robot 10 are prepared in advance and stored in the storage 13. The CPU 21 selects the contents of the timeline information 441 so that the timeline information 441 displayed in two consecutive unit time periods Tu are not identical. There may be a case in which none of the timeline information 441 for the unit time period Tu is displayed. Examples include, a case in which a state corresponding to the above four types is not detected based on the log 133 or the log DB 233 corresponding to the unit time period Tu, or a case in which there is no change from the state in the unit time period Tu that is one unit before. In this case, the next unit time period Tu is narrowed and displayed. Each timeline information 441 represents the state of the robot 10 in the one-hour unit time period Tu starting from the time displayed in a frame. For example, the timeline information 441 displaying "11:00" represents the state of the robot 10 in the unit time period Tu from 11:00 to 12:00. The timeline display region 44 is updated at a frequency of once an hour. The content of the timeline information 441 for the unit time period Tu is determined based on the log 133 corresponding to that unit time period Tu in the log DB 233. The log 133 in which the recording time period crosses the top of the hour is treated as the log 133 corresponding to the unit time period Tu that contains 1/2 or more of the recording time period. The timeline display region 44 normally displays the four most recent timeline information 441. Therefore, when one new timeline information 441 is generated based on the new log 133, that timeline information 441 is displayed at the most bottom of the timeline display region 44, and the existing timeline information 441 moves up one level. Therefore, one timeline information 441, which was displayed at the most top, is no longer displayed. The past timeline information 441 that is no longer displayed is accumulated in the timeline data 234. Thus, in the timeline display region 44, a portion of the plurality of timeline information 441 for a day is displayed in chronological order.

As shown in FIG. 11, according to the present embodiment, the user can perform the operation to designate a position in the graph display region 43 (e.g., tap a position) to display the timeline information 441 for a desired time frame from one day in the timeline display region 44. In other words, the CPU 21 derives a designated time point ts corresponding to the position operated by the user (hereinafter referred to as "designated position ps") for the time axis of the graph 432 as the designated time (amount of time). The timeline information 441 on display is scrolled in conjunction with the user's operation so that the timeline information 441 corresponding to this designated time point ts is displayed in the timeline display region 44. For example, the CPU 21 scrolls the timeline information 441 in the direction of the arrow D in FIG. 11 when transitioning the display from the state shown in FIG. 9 to the state shown in FIG. 11. In response to the timeline information 441 of a later time frame than the displayed timeline information 441 being displayed in response to the operation by the user designating the graph display region 43, the scroll direction is the opposite direction of FIG. 11. In detail, the CPU 21 first determines the unit time period Tu that satisfies the predetermined condition from among the plurality of (24) unit time periods Tu included in the first time period T1 based on the designated time point ts. Next, the CPU 21 changes a portion of the plurality of timeline information 441 generated on that day to be displayed in the timeline display region 44 so that the timeline information 441 corresponding to the determined unit time period Tu is displayed at an upper end position p (predetermined position) in the timeline display region 44.

The method for determining the unit time period Tu that satisfies the predetermined condition based on the designated time point ts is described. As shown in FIG. 12, in response to detecting the operation to designate the designated position ps in the graph display region 43, the CPU 21 derives the designated time point ts corresponding to the designated position ps in the time axis of the graph display region 43 based on the coordinates of the designated position ps. Next, the CPU 21 designates a second time period T2 that includes the designated time point ts. The second time period T2 is shorter than the first time period T1 and is a time period longer than the unit time period Tu. According to the present embodiment, for example, the length of the second time period T2 is 2 hours. The second time period T2 is each of the time periods in which one day is divided into 12 sections every 2 hours starting from midnight. The CPU 21 makes the region r corresponding to the second time period T2 that includes the designated time point ts in the graph display region 43 a predetermined highlighted display (e.g., colored in a predetermined color). In response to the second time period T2 that includes the designated time point ts including the unit time period Tu with the displayable timeline information 441, the CPU 21 selects such second time period T2 as the second time period T2 corresponding to the designated time point ts. Then, the CPU 21 determines the earliest unit time period Tu among the unit time periods Tu that are included in the selected second time period T2 and for which there is the displayable timeline information 441 as the unit time period Tu that satisfies the predetermined condition. In the example shown in FIG. 11, the designated time point ts is 16:20, and the second time period T2 including the designated time point ts is the time period from 16:00 to 18:00. The unit time period Tu from 16:00 to 17:00 and the unit time period Tu from 17:00 to 18:00 included in this second time period T2 have the displayable timeline information 441e and 441f, respectively. Therefore, the CPU 21 determines the unit time period Tu from 16:00 to 17:00, the earlier of these, as the unit time period Tu (the unit time period Tu corresponding to the designated time point ts) that satisfies the predetermined condition. Then, the CPU 11 scrolls the timeline information 441 so that the timeline information 441e for the unit time period Tu is displayed at the upper end position p.

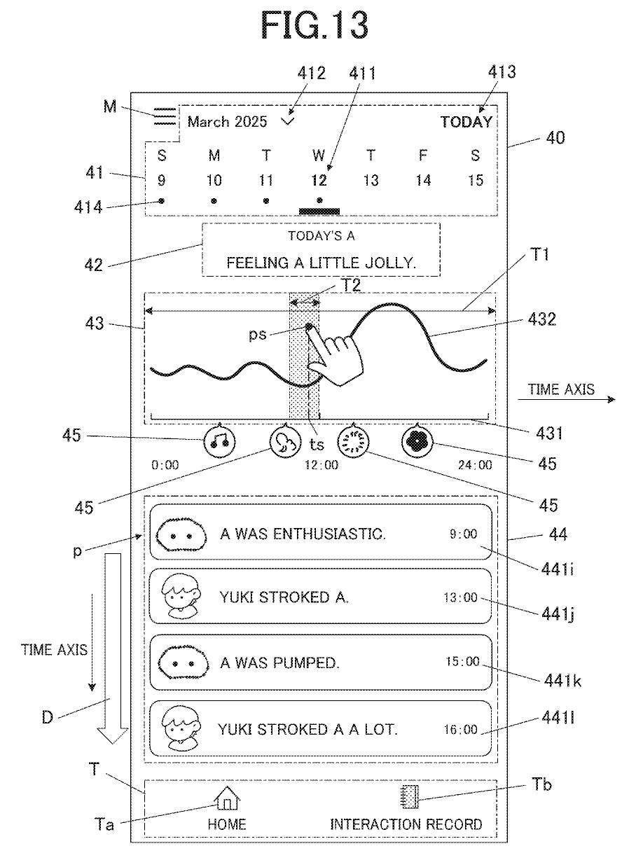

On the other hand, the second time period T2, which includes the designated time point ts, may not include the unit time period Tu, which includes the displayable timeline information 441. In this case, the CPU 21 selects the second time period T2 closest to the second time period T2 that includes the unit time period Tu with the displayable timeline information 441 and that includes the designated time point ts, among the other second time periods T2 prior to such second time period T2, as the second time period T2 corresponding to the designated time point ts. Then, the CPU 21 determines the earliest unit time period Tu among the unit time periods Tu that are included in the selected second time period T2 and for which there is the displayable timeline information 441 as the unit time period Tu that satisfies the predetermined condition. For example, in the example shown in FIG. 13, the designated time point ts is 11:10, and the second time period T2 including the designated time point ts is the time period from 10:00 to 12:00. There are no displayable timeline information 441 in any of the two unit time periods Tu included in this second time period T2. In this case, the CPU 21 traces back each second time period T2 one by one and determines whether each second time period T2 includes the unit time period Tu with the displayable timeline information 441. In FIG. 13, the unit time period Tu from 9:00 to 10:00, which is included in the one earlier second time period T2 from 8:00 to 10:00, contains displayable timeline information 441i. Therefore, the CPU 21 selects the second time period T2 from 8:00 to 10:00 as the second time period T2 corresponding to the designated time point ts, and determines the unit time period Tu from 9:00 to 10:00 as the unit time period Tu satisfying the predetermined condition. Then, the CPU 11 scrolls the timeline information 441 so that the timeline information 441e for the unit time period Tu is displayed at the upper end position p. For example, the CPU 21 scrolls the timeline information 441 in the direction of the arrow D in FIG. 13 when transitioning the display from the state shown in FIG. 9 or FIG. 11 to the state shown in FIG. 13.

The above operation of switching the display range of the timeline information 441 in response to the operation of designating the designated position ps in the graph display region 43 is not limited to the timeline information 441 of that day, but can be applied to the timeline information 441 of past days. In response to the day in the past being selected in the date selection section 41 or the calendar 46, the CPU 21 causes a portion of the plurality of timeline information 441 corresponding to the first time period T1 on the selected day to be displayed in the graph display region 43, and also causes the graph 432 representing the time-series change in the state parameter P over the first time period T1 for the selected day to be displayed in the graph display region 43. In a state in which the graph 432 and the timeline information 441 for the day in the past is displayed in this manner, the user performs the operation to designate the desired position in the graph display region 43. With this, it is possible to display the timeline information 441 at the desired time point on the day at the upper end position p of the timeline display region 44.

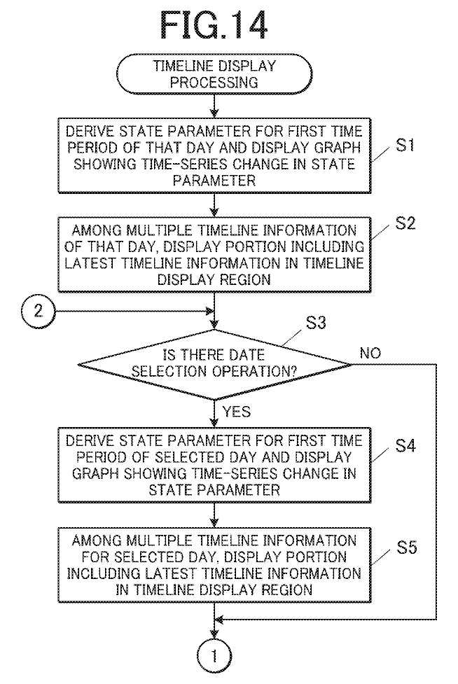

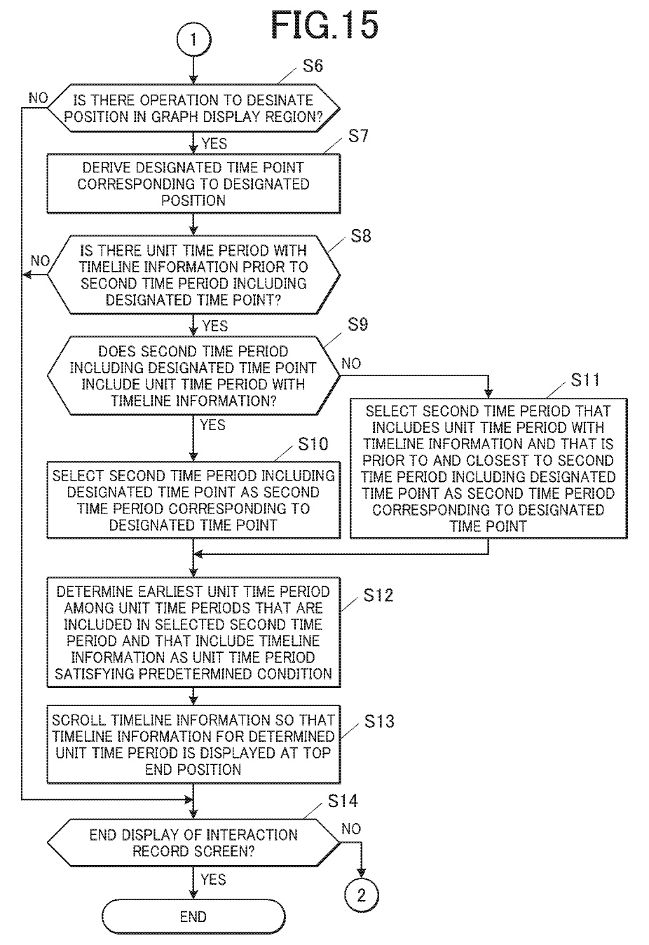

Next, with reference to FIGS. 14 and 15, the timeline display process executed by the CPU 21 to achieve the above operation for switching the timeline information 441 is described. The timeline display process is started in response to the interaction record screen 40 being displayed after the management application 231 is started. As shown in FIG. 14, in response to the timeline display process starting, the CPU 21 derives the state parameter P in the first time period T1 of the day based on the log DB 233 in the manner described above, and displays the graph 432 representing the time-series changes in the state parameter P in the graph display region 43 (step S1). Based on the log DB 233 and the timeline data 234, the CPU 21 displays a portion (four) of the multiple timeline information 441 for the day, including the latest timeline information 441, in the timeline display region 44 (step S2). At the same time, the CPU 21 executes various processes (not shown) to display other elements included in the interaction record screen 40 on the display 24 and displays the interaction record screen 40 on the display 24. The CPU 21 determines whether the date different from the date being displayed is selected in the date selection section 41 or calendar 46 (step S3). In response to determining that such selection is made("YES" in step S3), the CPU 21 derives the state parameter P in the first time period T1 of the selected day based on the log DB 233, and displays the graph 432 representing the time-series change on the state parameter P on the graph display region 43 (step S4). Based on the log DB 233 and the timeline data 234, the CPU 21 displays a portion (four) of the multiple timeline information 441 for the selected day, including the latest timeline information 441, in the timeline display region 44 (step S5).

In response to step S5 ending, or in response to determining that such selection of the date is not made ("NO" in step S3), the CPU 21 determines whether the position of the graph display region 43 is designated (step S6 in FIG. 15). In response to determining that the designation is received ("YES" in step S6), the CPU 21 derives the designated time point ts corresponding to the designated position ps based on the coordinates of the designated position ps (step S7). The CPU 21 determines whether there is the unit time period Tu with the displayable timeline information 441 before the second time period T2 that includes the designated time point ts (step S8). In response to determining that there is the unit time period Tu ("YES" in step S8), the CPU 21 determines whether the second time period T2 including the designated time point ts includes the unit time period Tu including the displayable timeline information 441 (step S9). In response to determining that the unit time period Tu including the displayable timeline information 441 is included ("YES" in step S9), the CPU 21 selects the second time period T2 that includes the designated time point ts as the second time period T2 corresponding to the designated time point ts (step S10). On the other hand, in response to step S9 branching to "NO," the CPU 21 selects the second time period T2 that is prior to and closest to the second time period T2 that includes the unit time period Tu with the displayable timeline information 441 and that includes the designated time point ts as the second time period T2 corresponding to the designated time point ts (step S11). In response to step S10 or S11 ending, the CPU 21 determines the earliest unit time period Tu among the unit time periods Tu that are included in the second time period T2 selected in step S10 or S11 and for which there is the timeline information 441 to be the unit time period Tu that satisfies the predetermined condition (step S12). The CPU 21 scrolls the timeline information 441 so that the timeline information 441 for the determined unit time period Tu is displayed at the upper end position p (step S13). In response to step S13 ending, or in response to either step S6 or S8 branching to "NO", the CPU 21 determines whether the operation to end the display of the interaction record screen 40 has been performed (step S14). In response to determining that no such operation has been performed ("NO" in step S14), the CPU 21 returns the process to step S3, and in response to determining that such operation has been performed ("YES" in step S14), the timeline display process ends.

A modification example of the above embodiments are described below. According to the above embodiments, the example shows a manner in which the smartphone 20 executes various processes according to the management application 231 to display the home screen 30 and the interaction record screen 40, but it is not intended to limit the embodiments to such example. For example, a server (such as the server 60 shown in FIG. 1) provided outside the smartphone 20 may control the display 24 of the smartphone 20 by sending data to the smartphone 20 to display the home screen 30 and the interaction record screen 40, etc. on the display 24. In this case, the server's computer executes the information processing method to generate control data for the CPU 21 as the other computer to execute the following process. The above-mentioned control data includes, "data for causing the CPU 21 (another computer) to execute a process of displaying, in chronological order, a portion of the plurality of timeline information 441 representing the state of the robot 10 in the unit time period Tu included in the first time period T1 based on the log DB 233 representing the history of the state of the robot 10 in the timeline display region 44 of the display 24, and a process of displaying the graph 432 representing the chronological change of the state parameter P in the log DB 233 in the first time period T1 in the graph display region 43 different from the timeline display region 44 on the display 24". In response to receiving an operation designating the designated position ps in the graph display region 43, the CPU of the server determines, based on the designated time point ts corresponding to the designated position ps in the time axis of the graph 432, the unit time period Tu that satisfies the predetermined condition described above from among the plurality of unit time periods Tu included in the first time period T1. The above control data includes "data for causing the CPU 21 to execute the process to change a portion of the plurality of timeline information 441 to be displayed in the timeline display region 44 so that the timeline information 441 corresponding to the determined unit time period Tu among the plurality of timeline information 441 is displayed at a predetermined position (such as the upper end position p) in the graph display region 43. The control data may include data designating the content and structure of the interaction record screen 40, such as image data or HTML (Hyper Text Markup Language) data. The control data may also include control information to control the operation of the display 24. The control data may also be a program for displaying the interaction record screen 40 on the display 24.

In the conventional technology, the state of an object such as a robot is maintained as an internal parameter of the object, therefore it was not always easy to accurately understand the history of the state of the object from the outer appearance of the object.

According to the present disclosure, it is possible to easily understand the history of the state of the object.

According to the present disclosure, responsiveness to user operation improves and efficiency of display control is realized compared to conventional display methods.

In addition, by linking the first display region and the second display region, it is expected to reduce the processing load required to search and refer to the history information and optimize the calculation for the display update, thereby enabling more effective use of computer resources. With this, it is possible to expect technical improvement regarding not only the mere presentation of information, but also regarding speeding up a rendering process in a display control apparatus.

According to the display control method of the present embodiment, the CPU 21 displays a portion of the plurality of timeline information 441 representing the state of the robot 10 in each unit time period Tu included in the first time period T1, based on the log DB 233 pertaining to the history of the state of the robot 10, in the timeline display region 44 of the display 24 in chronological order. The CPU 21 displays the graph 432 representing the time-series change in the first time period T1 of the state parameter P pertaining to the log DB 233 in the graph display region 43 that is different from the timeline display region 44 in the display 24. In response to receiving the operation designating the designated position ps in the graph display region 43, the CPU 21 determines the unit time period Tu that satisfies the predetermined condition from among multiple unit time periods Tu included in the first time period T1 based on the designated time point ts corresponding to the designated position ps in the time axis of the graph 432. The CPU 21 changes a portion of the plurality of timeline information 441 to be displayed in the timeline display region 44 so that the timeline information 441 corresponding to the determined unit time period Tu among the plurality of timeline information 441 is displayed at the upper end position p in the timeline display region 44. This enables a configuration to be able to visually grasp the transition of the state parameter P of the robot 10 by displaying the graph 432 in the graph display region 43. Moreover, this enables a configuration to be able to easily grasp the history of the state of the robot 10, which changes due to communication with the user, etc., by displaying the timeline information 441 in chronological order in the timeline display region 44. In response to the operation designating any designated position ps in the graph display region 43, the timeline information 441 corresponding to the designated position ps can be displayed at the upper end position p of the timeline display region 44. From another perspective, the user can designate a desired designated time point ts by designating the position in the graph display region 43, and can easily check the timeline information 441 corresponding to that designated time point ts. Thus, the user can easily check the communication between the robot 10 and the user and the external stimuli received by the robot 10 during the time frame near the designated time point ts.

The CPU 21 displays a portion of the plurality of timeline information 441 in the timeline display region 44 aligned in the vertical direction, and the predetermined position is the upper end position p of the timeline display region 44 in the vertical direction. This allows the timeline information 441 corresponding to the designated time point ts to be displayed in a position easily visible to the user.

In response to receiving the operation designating the designated position ps in the graph display region 43, the CPU 21 selects the second time period T2 that corresponds to the designated time point ts, and that is shorter than the first time period T1 and longer than the unit time period Tu. The CPU 21 determines the earliest unit time period Tu among the unit time periods Tu that are included in the selected second time period T2 and for which there is the displayable timeline information 441 as the unit time period Tu that satisfies the predetermined condition. As described above, according to a method performed by selecting the second time period T2 with a constant time span according to the designated time point ts and displaying the timeline information 441 included in the second time period T2 at the upper end position p, the timeline information 441 desired by the user can be displayed at the upper end position p even if the designated position ps and the designated time point ts are slightly shifted.

In response to the second time period T2 that includes the designated time point ts including the unit time period Tu with the displayable timeline information 441, the CPU 21 selects such second time period T2 as the second time period T2 corresponding to the designated time point ts. In response to the second time period T2 that includes the designated time point ts not including the unit time period Tu that has the displayable timeline information 441, the CPU 21 selects, among the other second time periods T2 before the above second time period T2, the second time period T2 that includes the unit time period Tu that has the displayable timeline information 441 and that is closest to the second time period T2 that includes the designated time point ts as the second time period T2 corresponding to the designated time point ts. This allows the alternative timeline information 441 to be displayed at the upper end position p even in response to the second time period T2, which includes the designated time point ts, not including the displayable timeline information 441.

The first time period T1 is a predetermined time frame of at least a part of one day. This allows the graph 432 to show the time-series changes in the state parameter P of the robot 10 over one day.

In response to processing to display the calendar 46 on the display 24, and receiving the operation selecting a day in the calendar 46, the CPU 21 displays a portion of the plurality of timeline information 441 corresponding to the first time period T1 on the selected day in the timeline display region 44, and in response to receiving the operation selecting the day, the CPU 21 displays the graph 432 representing the time-series change of the state parameter P over the first time period T1 on the selected day in the graph display region 43. This allows the user to display the graph 432 and the timeline information 441 for any desired day. Furthermore, by receiving the operation of designating the designated position ps in the graph display region 43, the timeline information 441 at any time point on any day desired by the user can be displayed at the upper end position p.

By using the unit time period Tu of a predetermined length as the target time period, the timeline information 441 representing the representative state of the robot 10 for each unit time period Tu can be displayed in the timeline display region 44.

The display control apparatus 200 according to the present embodiment includes the CPU 21 that executes the above process. This enables a configuration to be able to easily grasp the history of the state of the robot 10. The robot management system 1 according to the present embodiment includes the robot 10 and the display control apparatus 200 including the CPU 21 that executes the above process. This enables a configuration to be able to easily grasp the history of the state of the robot 10.

The present disclosure is not limited to the above-described embodiments, and various modifications are possible. For example, the graph 432 is not limited to the example representing the time-series change of the state parameter P exemplified in the above-described embodiment, and the graph 432 may also represent the time-series change of any parameter based on the log DB 233 (history information).

The upper end position p in the timeline display region 44 is exemplified as the predetermined position in the first display region, but the example is not limited to this. For example, the predetermined position may be a lower end position in the timeline display region 44, or may be another position that is easily visible to the user, such as the center position. In a case in which the timeline information 441 is arranged in a horizontal (right-left) direction in the timeline display region 44, the predetermined position may be a right end position or a left end position in the timeline display region 44.

As the unit time period Tu that satisfies the predetermined condition, the unit time period Tu that is included in the second time period T2 corresponding to the designated time point ts and that is earliest among the unit time period Tu in which there is the displayable timeline information 441 is exemplified, but the present embodiment is not limited to such unit time period Tu. For example, the unit time period Tu that satisfies the predetermined conditions may be determined without involving the selection of the second time period T2. As one example, among the unit time period Tu in which there is the displayable timeline information 441, the unit time period Tu that is prior to and closest to the designated time point ts may be the unit time period Tu that satisfies the predetermined condition. Although the unit time period Tu of a predetermined length is shown as an example of the target time period, the length of the target time period does not necessarily have to be constant. Although a designated time point ts is shown as an example of the designated time, the designated time does not necessarily have to represent the time point, and the designated time can also represent a time frame.

The first time period T1 is illustrated as a 24-hour time period on a day, but is not limited to this. For example, the first time period T1 may be the time frame in which the robot 10 is active (e.g., 6:00 am to 12:00 midnight, etc.) set within one day. In this case, the range of the coordinate axis 431 of the graph 432 may match with this first time period T1 (active time frame).

The contents of the log 133 (and the log DB 233 in which the log 133 is accumulated) are not limited to those shown in FIG. 4 and may include other elements representing the state of the robot 10. For example, the elements of the state of the robot 10 may include elements such as fatigue, sleepiness, physical condition, etc.

The example shows how the home screen 30 and the interaction record screen 40 are displayed on the display 24 of the smartphone 20, but is not limited to this. For example, in a case in which the robot 10 includes a display, the home screen 30 and the interaction record screen 40 may be displayed on such display. In this case, the control for displaying the home screen 30 and the interaction record screen 40 may be executed by the CPU 11 of the robot 10 or may be executed remotely by a processor of an external device such as the CPU 21 of the smartphone 20.

The configuration of the robot 10 is not limited to the configuration illustrated in FIG. 1 to FIG. 3. For example, the robot 10 may be the robot that imitates a real creature such as a person, animal, bird, fish, or the like, a robot that imitates a non-existent creature such as a dinosaur, or a robot that imitates a fictional creature.

According to the above embodiment, the example of the robot 10 as the "object" is shown but the "object" is not limited to this. The "object" can be anything that is to be an object of management by the management application 231. For example, the "object" may be any object in which the parameters representing the object’s state change. The "object" may be an avatar that operates on behalf of the user in a virtual space such as the Metaverse.

The above description also discloses an example of using flash memory in the storage 13 and the storage 23 as a computer-readable medium for the program of the present disclosure, but it is not limited to this example. As other computer-readable media, information recording media such as HDD (Hard Disk Drive), SSD (Solid State Drive), CD-ROM, etc. can be applied. A carrier wave is also applicable to the present disclosure as a medium for providing data for the program according to the present disclosure via communication lines. In addition, the detailed configuration and the detailed operation of each component of the robot 10 and smartphone 20 according to the above embodiments can be suitably modified without departing from the scope of the present disclosure. The embodiments of the present disclosure are described above. However, the scope of the present disclosure is not limited to the embodiments described above, and includes the scope of the invention described in the claims and its equivalents.

1. A display control method executed by one or more processors, the method comprising:
based on history information representing history of a state of an object, displaying a portion of a plurality of time period information representing the state of the object in a predetermined first time period in chronological order in a first display region of a display;
displaying a graph representing a time-series change of a parameter regarding the history information in the first time period in a second display region different from the first display region of the display;
in response to receiving an operation designating a position in the second display region, based on a designated time corresponding to the designated position along a time axis of the graph, determining a target time period that satisfies a predetermined condition from among a plurality of target time periods within the first time period; and
changing a portion of the plurality of time period information to be displayed in the first display region in a manner in which the time period information corresponding to the determined target time period among the plurality of time period information is displayed at a predetermined position in the first display region.

2. The display control method according to claim 1, further comprising,
displaying a portion of the plurality of time period information in a direction in the first display region,
wherein the predetermined position is an edge of the first display region in the direction.

3. The display control method according to claim 1, further comprising,
in response to receiving the operation designating the position in the second display region, selecting a second time period which corresponds to the designated time, and which is shorter than the first time period and longer than the target time period, and
determining the target time period that is included in the selected second time period and that is earliest of the target time period including the time period information that is displayable as the target time period that satisfies the predetermined condition.

4. The display control method according to claim 3, further comprising,
in response to the second time period that includes the designated time including the target time period with the time period information that is displayable, selecting the second time period as the second time period corresponding to the designated time, and
in response to the second time period that includes the designated time not including the target time period with the time period information that is displayable, selecting, among another second time period before the second time period, the second time period closest to the second time period that includes the target time period with the time period information that is displayable and that includes the designated time as the second time period corresponding to the designated time.

5. The display control method according to claim 1, wherein the first time period is a predetermined time frame of at least a part of one day.

6. The display control method according to claim 5, further comprising,
displaying a calendar on the display,
in response to receiving the operation selecting a day in the calendar, displaying a portion of the plurality of time period information corresponding to the first time period in the day in the first display region, and
in response to receiving the operation selecting the day, displaying the graph representing the time-series change of the parameter over the first time period on the day in the second display region.

7. The display control method according to claim 1, wherein the target time period is a unit time period with a predetermined length.

8. A display control apparatus comprising:
one or more processors,
wherein the one or more processors are configured to execute,
based on history information representing history of a state of an object, displaying a portion of a plurality of time period information representing the state of the object in a predetermined first time period in chronological order in a first display region of a display;
displaying a graph representing a time-series change of a parameter regarding the history information in the first time period in a second display region different from the first display region of the display;
in response to receiving an operation designating a position in the second display region, based on a designated time corresponding to the designated position along a time axis of the graph, determining a target time period that satisfies a predetermined condition from among a plurality of target time periods within the first time period; and
changing a portion of the plurality of time period information to be displayed in the first display region in a manner in which the time period information corresponding to the determined target time period among the plurality of time period information is displayed at a predetermined position in the first display region.

9. A display system comprising:
an object; and
a display control apparatus,
wherein one or more processors are configured to execute,
based on history information representing history of a state of the object, displaying a portion of a plurality of time period information representing the state of the object in a predetermined first time period in chronological order in a first display region of a display;
displaying a graph representing a time-series change of a parameter regarding the history information in the first time period in a second display region different from the first display region of the display;
in response to receiving an operation designating a position in the second display region, based on a designated time corresponding to the designated position along a time axis of the graph, determining a target time period that satisfies a predetermined condition from among a plurality of target time periods within the first time period; and
changing a portion of the plurality of time period information to be displayed in the first display region in a manner in which the time period information corresponding to the determined target time period among the plurality of time period information is displayed at a predetermined position in the first display region.
